(19) United States
(12) Patent Application Publication
(10) Pub. No.: US 2026/0346560 A1
(43) Pub. Date: Nov. 5, 2026

(54) A ROTARY TABLET PRESS COMPRISING A DUST EXTRACTION SYSTEM AND AN EMPTYING ARRANGEMENT, AND A METHOD OF CLEANING A ROTARY TABLET PRESS

(71) Applicant: GEA Process Engineering NV, Halle (BE)

(72) Inventors: Nicolas Robin, Halle (BE); James William Holman, Halle (BE); Frederik Detobel, Halle (BE)

(73) Assignee: GEA Process Engineering NV, Halle (BE)

(21) Appl. No.: 19/099,912

(22) PCT Filed: Aug. 21, 2023
(86) PCT No.: PCT/EP2023/072944

§ 371 Date: Jan. 30, 2025

(30) Foreign Application Priority Data
Aug. 19, 2022 (EP) 22191302.3

(51) Int. Cl. B30B 11/08; A61J 3/10; B30B 15/00; B30B 15/30

(52) U.S. Cl. CPC B30B 11/08; A61J 3/10; B30B 15/0082; B30B 15/302

(57) ABSTRACT

A rotary tablet press comprising a dust extraction system and an emptying arrangement, and a method of cleaning a rotary tablet press. The rotary tablet press (1) comprises a housing (2) with a compression section (6), a turret (10) positioned in the compression section in an operational position, at least one filling device (12) associated with the turret (10), and a dust extraction system (16) including a suction device and an extraction nozzle having an opening in the compression section (6). The dust extraction system (16) is configured to extract dust from the compression section (6) to the suction device (19) via piping of the dust extraction system during operation of the rotary tablet press. The rotary tablet press comprises an emptying arrangement (80) configured to allow emptying the filling device (12) of residual powder, and the emptying arrangement (80) is connected to or connectable to the dust extraction system (16) of the rotary tablet press (1).

### TECHNICAL FIELD

The present invention relates to a rotary tablet press comprising a housing with a compression section, a turret positioned in the compression section in an operational position, at least one filling device associated with the turret, and a dust extraction system including a suction device, piping, and an extraction nozzle having an opening in the compression section, the dust extraction system being configured to extract dust from the compression section to the suction device via the piping of the dust extraction system during operation of the rotary tablet press. The invention furthermore relates to a method of cleaning a rotary tablet press.

### BACKGROUND ART

Such rotary tablet presses need to be cleaned at regular intervals, either due to a scheduled cleaning procedure, or at the end of a production batch or in case of troubleshooting a feeder obstruction. In particular in the case of a product change-over, it is vital that the filling device is emptied completely for unused powder before the cleaning procedure is initiated.

It is known to carry out the emptying procedure by connecting an external vacuum cleaner to the filling device in order to remove residual powder from the components of the filling device, i.e. the powder distribution device, or fill shoe, the powder inlet tube, and possibly parts of the feeder. When the external vacuum cleaner is to be connected to and disconnected from the filling device, these operations need to be carried out in a contained manner to avoid or at least reduce the risk of contamination of the premises. In particular in the case of potent powders containing a pharmaceutical component, exposure of the powder may impose a health risk to the operator. The contained connection is typically obtained by means of Layflat Tubing (LFT), and after disconnecting the external vacuum cleaner, the LFT remains connected to the filling device to close of the filling device.

Subsequent washing of the components of the rotary tablet press is carried out by supplying water and/or a cleaning liquid comprising a detergent. In this regard, the closed-off LFT poses a problem since the LFT will form a dead-end pipe in which stagnant water may remain. Disconnecting the LFT will lead to contaminated fluid in the compression section of the rotary tablet press. A further challenge in the described cleaning procedure is that the external vacuum cleaner needs to be cleaned as well, typically by means of a cleaning liquid and water.

In the prior art, WO 03/020499 A1 shows and describes a rotary tablet press in which a compression unit is detachably mounted in the housing. The detachable compression unit is removed from the housing and brought to a dedicated cleaning station, while an already cleaned unit replaces the removed compression unit, without delaying the production.

A further example of a rotary tablet press with a dust extraction system is shown and described in US 2008/0029915 A1, which incorporates a further development of the compression unit of WO 03/020499 A1, and in which a non-return valve is present to provide communication to the surroundings of the tablet press such that air is allowed to enter and dust is prevented from leaving the compression chamber of the tablet press.

Another rotary tablet press is shown and described in CN 101138889 A, in which a dust collection system comprises a vacuum cleaner which via vacuum tubes removes material by means of a vacuum connector mounted on the feeder.

It is a general desire to improve the cleaning conditions in such a rotary tablet press, not least from the perspective of usage of resources such as water and time.

### SUMMARY OF THE INVENTION

An object of the present invention is to address the above-mentioned drawbacks, in particular to provide a rotary tablet press allowing for facilitated cleaning.

In a first aspect, this and further objects are achieved by a rotary tablet press of the kind mentioned in the introduction, which is furthermore characterized in that the rotary tablet press comprises an emptying arrangement configured to allow emptying the filling device of residual powder, and that the emptying arrangement is connected to or connectable to the dust extraction system of the rotary tablet press.

By providing an emptying arrangement and combining the emptying arrangement with the dust extraction system of the rotary tablet press, the need for an external vacuum cleaner that has to be connected, disconnected, and subsequently cleaned has been eliminated.

The term “emptying arrangement” is to be interpreted as encompassing one or more arrangements of varying complexity, configured to substantially vacate a designated space of its contents.

Since the dust extraction system is in any event present in the rotary tablet press to prevent accumulation of powder within the compression section during operation, the additional resources required are limited to the costs of providing the emptying arrangement and establishing the connection to the dust extraction system.

Optimum flexibility as to the applicability of the emptying arrangement is achieved, as the emptying arrangement may be provided in an installed state in the rotary tablet press or be provided as a separate entity to be connected to the dust extraction system at any suitable point in time, typically when it is desired to perform an emptying procedure. Such an emptying procedure is for instance relevant when a test run has been completed, or if an obstruction or jamming has occurred, or in the case of a product change-over, or when cleaning is desired or prescribed as part of a cleaning regimen. In particular, providing the emptying arrangement as a separate entity allows easy retrofitting to an existing rotary tablet press; in this way, the possibility is afforded of supplying a rotary tablet press in a standard edition, which may be upgraded at a later point in time.

In one embodiment, the emptying arrangement comprises a powder discharge pipe connected to or connectable to the filling device and configured to bring the filling device in connection with the suction device of the dust extraction system. This embodiment also provides for improved flexibility in the configuration of the emptying arrangement as the powder discharge pipe of the emptying arrangement may either be permanently connected to the filling device, or form part of a separate entity as described in the above.

In one presently preferred development of the above-described embodiment, the piping of the dust extraction system comprises a dust extraction pipe connecting the extraction nozzle with the suction device of the dust extraction system, and the powder discharge pipe of the emptying arrangement is connected to said dust extraction pipe. This provides for a structurally simple configuration requiring connection between the two pipes of the emptying arrangement and the dust extraction system, respectively.

The dust extraction pipe of the dust extraction system may be connected to the powder discharge pipe by means of a manifold, and the piping of the dust extraction system may comprise a suction pipe connecting the manifold with the suction device of the dust extraction system. The use of a manifold a simple way of connecting pipes.

In a further development, the powder discharge pipe of the emptying arrangement is connected to the manifold. By this configuration, the connection between the pipes is facilitated to an even further extent and the solution contributes to the overall flexibility in the configuration rotary tablet press, since pipes may be removed and replaced independently of other pipes.

In an alternative embodiment, the powder discharge pipe is configured to bring the filling device in direct connection with the suction device of the dust extraction system. While this embodiment provides for a simplified piping, it also requires an additional connection at the suction device of the dust extraction system.

It may be desirable to provide for selective communication between the extraction nozzle and the suction device of the dust extraction system on one hand, and between the filling device and the suction device on the other. In one presently preferred embodiment, the emptying arrangement is selectively connectable to and disconnectable from the dust extraction system by means of at least one valve configured to assume a plurality of operational positions including a closed and an open position. In this way, it is possible to obtain an open communication between the extraction nozzle and the filling device during operation of the rotary tablet press, and conversely, allow for a single, open communication path between the filling device and the suction device during the emptying procedure. Such valve or valves may be manually or automatically operated.

In an advantageous development of the preferred embodiment, a first valve comprises a shut-off valve associated to the filling device and configured to assume a closed position during operation of the rotary tablet press and an open position during an emptying procedure so as to establish connection between the filling device and the powder discharge pipe in the open position of the shut-off valve. The use of a shut-off valve provides for reliable and stable open and closed positions.

Additionally or alternatively, a second valve is associated to the dust extraction pipe leading from the extraction nozzle and configured to assume an open position during operation of the rotary tablet press and a closed position during the emptying procedure of the filling device. In principle, the connection between the extraction nozzle and the suction device may remain open also during the emptying procedure; however, it is believed that closing the dust extraction pipe may improve the performance of the emptying arrangement.

In a further embodiment, the emptying arrangement is configured to be connected to a washing system, preferably by means of a washing pipe. In this way, a complete cleaning procedure may be carried out. Within the context of the present application, the term “cleaning” should be interpreted as encompassing emptying and de-dusting of components of the rotary tablet press, in particular within the compression section thereof, as well as washing by means of water and/or a cleaning liquid containing for instance a detergent.

The presence of a washing system is particularly advantageous in embodiments comprising a manifold. In this case, the manifold is connected to a draining pipe leading to a drainage discard system, preferably via a draining valve. The drainage discard system may for instance form part of the factory draining facilities.

In a presently preferred embodiment, the rotary tablet press comprises an enclosure surrounding the turret in its operational position in the compression section of the rotary tablet press, said enclosure comprising a bottom wall, a top wall substantially parallel to the bottom wall, and a plurality of side walls extending between the bottom wall and the top wall. The enclosure provides for improved containment within the compression section of the rotary tablet press and thus reduced the risk of exposure of the operating personnel even further.

The bottom wall of the enclosure may be provided as a plurality of hopper shapes, preferably comprising a rear and front hopper shape in the bottom wall of the enclosure, or as comprising two inclined inner portions. This feature improves the cleaning performance even further, since remaining dust and/or contaminated fluid such as water or cleaning liquid may flow to designated collection areas.

The dust extraction pipe and/or the powder discharge pipe may be provided with a draining valve. This eases draining of the compression section of the rotary tablet press.

It is particularly advantageous if the powder discharge pipe of the emptying arrangement is connected to the manifold at a level above the connection of the dust extraction pipe to the manifold, as this configuration provides for improved possibilities of emptying and cleaning the compression section completely.

A draining valve or draining valves may form part of a further aspect, in which a rotary tablet press is provided, comprising a housing with a compression section, a turret positioned in the compression section in an operational position, a dust extraction system comprising a dust extraction pipe and optionally an emptying arrangement comprising a powder discharge pipe, and an enclosure surrounding the turret in its operational position in the compression section of the rotary tablet press, said enclosure comprising a bottom wall, a top wall, and a plurality of side walls extending between the bottom wall and the top wall. In this aspect, the dust extraction pipe and/or the powder discharge pipe is provided with a draining valve.

In a further development of this aspect, the bottom wall of the enclosure is provided as a plurality of hopper shapes, preferably comprising a rear and front hopper shape in the bottom wall of the enclosure, or as comprising two inclined inner portions.

While the above described further aspect is applicable independently to rotary tablet presses in which there is no connection between the dust extraction system and the emptying arrangement, the further aspect is applicable to embodiments of the present invention as well.

In a second aspect of the invention, a method of cleaning a rotary tablet press is provided. The method comprises the steps of:
connecting the emptying arrangement to the dust extraction system of the rotary tablet press, and
carrying out an emptying procedure to empty the filling device of residual powder by sucking the residual powder by means of the suction device of the dust extraction system.

In an exemplary further development of the method, the step of connecting the emptying arrangement to the dust extraction system comprises opening a first valve comprising a shut-off valve associated to the filling device to establish connection between the filling device and a powder discharge pipe.

In case a second valve associated to the dust extraction pipe leading from the extraction nozzle is present, the second valve may be brought to a closed position before initiating the emptying procedure. Such a valve may for instance include a shut-off valve.

Finally, the method may comprise the additional step of supplying a washing fluid to the filling device following the emptying procedure.

Presently preferred embodiments and further advantages will be apparent from the subsequent detailed description and drawings. A person skilled in the art will appreciate that any one or more of the above aspects of this disclosure and embodiments thereof may be combined with any one or more of the other aspects of the disclosure and embodiments.

### BRIEF DESCRIPTION OF DRAWINGS

In the following description embodiments of the invention will be described with reference to the drawings, in which

FIG. 1 is a perspective view of a rotary tablet press in an embodiment of the invention, as seen from a front side of the rotary tablet press;

FIG. 2 is a perspective view of the rotary tablet press of FIG. 1, on a larger scale and from the front side, some parts being removed for ease of reading;

FIG. 3 is a perspective view corresponding to FIG. 2, seen from a back side of the rotary tablet press;

FIGS. 4 and 5 are perspective views, from different angles, of details of a rotary tablet press in embodiments of the invention;

FIGS. 6 and 7 are cross-sectional views; and

FIGS. 8 to 10 are schematic views indicating generalized configurations of embodiments of the rotary tablet press.

### DETAILED DESCRIPTION

The present invention will now be described in more detail hereinafter with reference to the accompanying drawings, in which an embodiment of the invention is shown. This invention may, however, be embodied in many different forms and should not be construed as limited to the embodiments set forth herein; rather, these embodiments are provided for thoroughness and completeness.

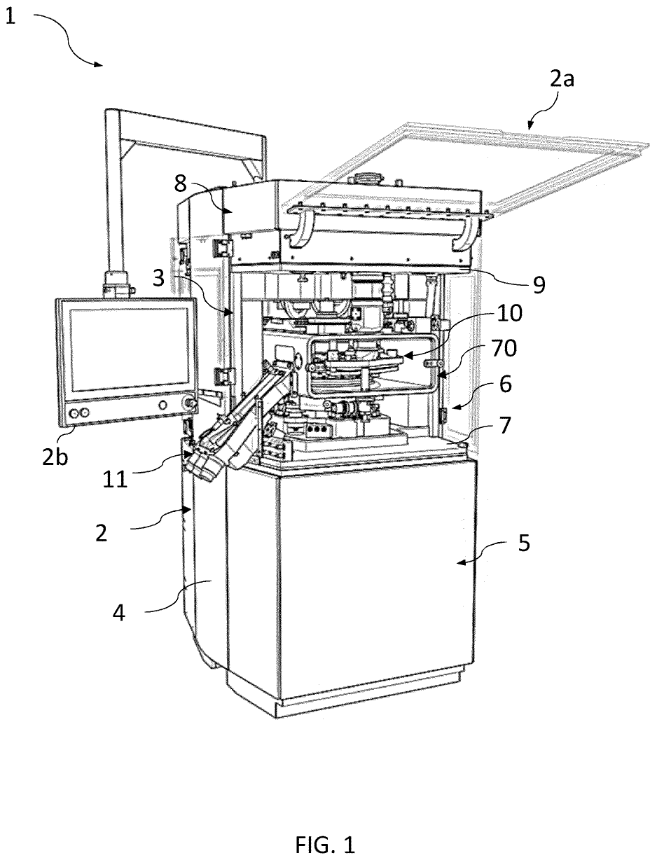

Referring first to the schematic overview of FIG. 1 showing a rotary tablet press generally designated 1 from a front side of the rotary tablet press 1, the rotary tablet press 1 has a housing 2 comprising a frame 3 and an outer lining 4. The housing 2 is composed of three sections, which are located on top of each other and are separated by means of partition walls. The lower section, designated the drive section 5, is separated from a central section, designated the compression section 6, by a bottom frame 7 of the rotary tablet press 1, and the compression section 6 is separated from an upper section, designated the accessory section 8, by a top frame 9 of the rotary tablet press 1. A wall element 2a is openable as indicated by the position shown in FIG. 1; during operation, the wall element 2a closes off the compression section 6. FIG. 1 further shows a display 2b. Further parts may be present but not shown, including caps to prevent excessive contamination of mechanical parts within the compression section 6.

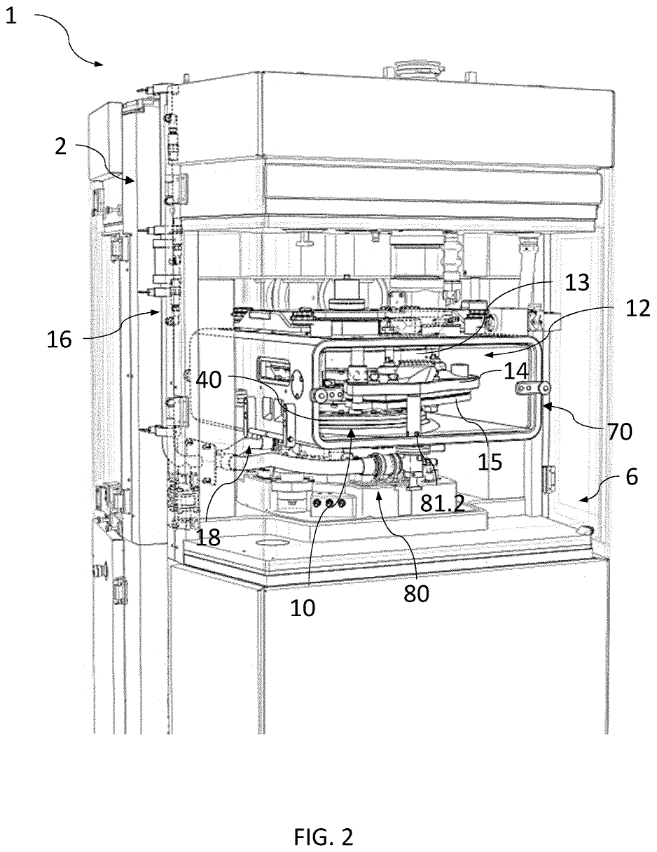

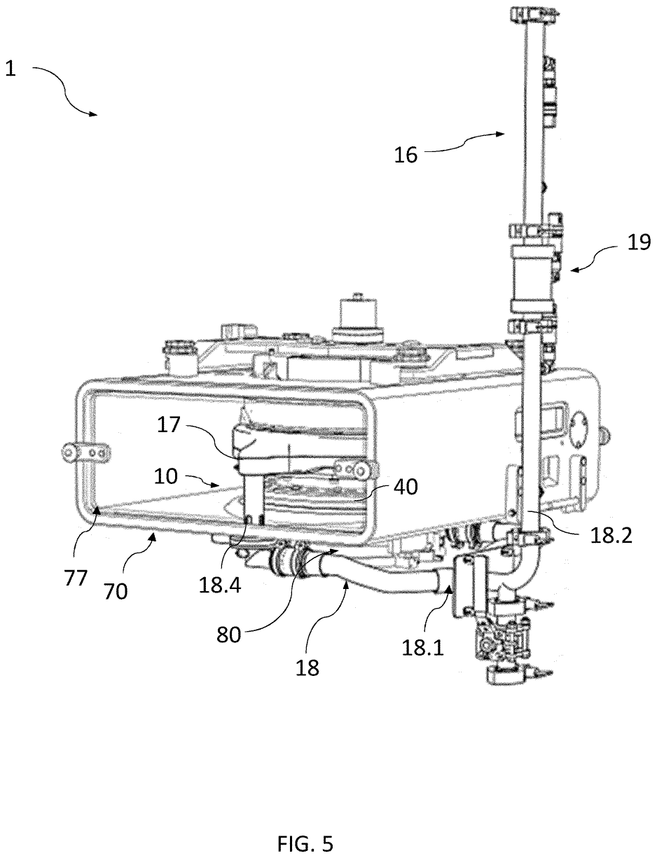

In a manner known per se the housing 2 accommodates a turret 10, parts of which are shown in more detail in FIGS. 2 to 7. During operation of the tablet press, the turret 10 is positioned in an operational position in the compression section 6 of the housing 2, but may be removed from the compression section 6 in order to allow cleaning, change-over of parts etc. The turret 10 comprises a plurality of rotating parts of which only a die disc 40 is indicated. The die disc 40 is substantially plate-shaped with a die disc surface and has a number of bores, typically accommodating a corresponding number of dies adapted for forming the tablets to the desired shape and size. Alternatively, the bores themselves are adapted to the desired tablet shape and size. Further parts include top and bottom punch guides with guide bores in which top and bottom punches are accommodated reciprocally so that a first end of each punch is able to enter a corresponding die, or the bore itself, if no die is present, by displacement of the associated punch in its guide bore, in order to compress material in the die or bore.

Further details indicated in FIG. 1 include a tablet chute 11 protruding from the turret 10 at an angle for conducting away compressed material in the form of tablets from the die bores. The tablet chute 11 is one of a number of auxiliary components associated with the turret 10.

In the embodiment shown, the turret 10 is accommodated in an enclosure 70 which is configured to be removed from the compression section 6 together with the turret 10 and any other auxiliary components connected to the turret 10 in case cleaning and/or change-over is scheduled. Alternatively, the enclosure 70 remains in the compression section 6 while only the turret 10 is removed. It is noted that the principle underlying the invention is applicable also to rotary tablet presses in which no such enclosure is present. Referring now also to FIGS. 2 to 7, the enclosure 70 comprises a bottom wall 71 and a top wall 72 substantially parallel to the bottom wall 71. In the embodiment shown, the enclosure comprises two substantially plane side walls 73, 74 extending between the bottom wall 71 and the top wall 72 and placed opposite relative to each other. A set of two separate, openable end covers 77, 78 is provided.

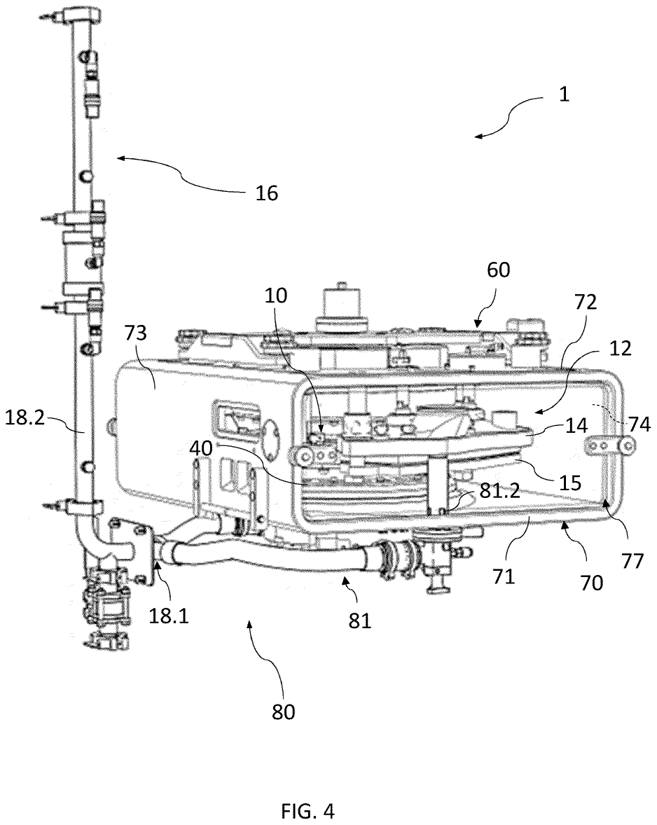

Further details not shown may include a scraper adapted to scrape off excess powder, thereby ensuring that only the desired amount of powder is present in the die disc, an ejection finger, a recuperation finger and further cams. Other elements may be present in the rotary tablet press 1 and means for controlling the tablet press according to desired settings may be provided as well. The auxiliary components of the rotary tablet press 1, including the enclosure 70, are carried by a support assembly comprising a suspension device 60 (cf. FIG. 4).

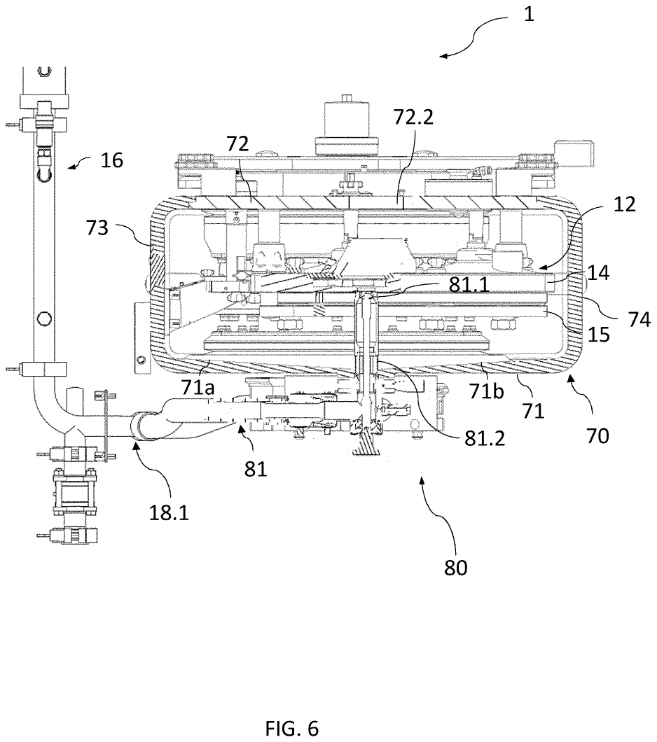

A filling device 12 is associated with the turret 10 is indicated. In the embodiment shown, the filling device 12 is located above the die disc 40 of the turret 10; however, in other embodiments two or more filling devices may be presen, just as more than the shown one turret 10 may be present. The filling device 12 comprises a powder distribution device 14, also denoted a fill shoe, connected to a feeder 15 and to a powder inlet tube 13. In turn, the powder inlet tube 13 is connected to a supply of powder, not shown. The filling device 12 ensures that the dies or bores in the die disc 40 are provided with powder or granules during operation of the rotary tablet press 1. In the embodiment shown, in which the turret 10 is accommodated in the enclosure 10, the top wall 72 comprises an opening 72.2 (cf. FIG. 6) for the powder inlet tube 13. Further openings in the enclosure 70 may be provided as well, although not indicated in detail. Examples of prior art enclosures are above-mentioned WO 03/020499 A1 resulting in EP 1 423 260 B1 to Courtoy and the commercially available tablet press MODUL™ making use of the Exchangeable Compression Module (ECM) concept. Another example is found in Applicant's co-pending PCT application PCT/EP2022/059803.

A dust extraction system generally designated 16 is provided and includes a suction device 19 and an extraction nozzle 17 having an opening in the compression section 6. The dust extraction system 16 is configured to extract dust from the compression section 6 to the suction device 19 via piping represented by a dust extraction pipe generally designated 18 of the dust extraction system 16 during operation of the rotary tablet press. The dust extraction system 16 may comprise further extraction nozzles than the one extraction nozzle 17 shown; typically, such further extraction nozzles will be distributed over the circumference of the die disc 40. The suction device 19 is indicated only schematically in the drawing figures; it lies within the competence of the skilled person to devise suitable suction means.

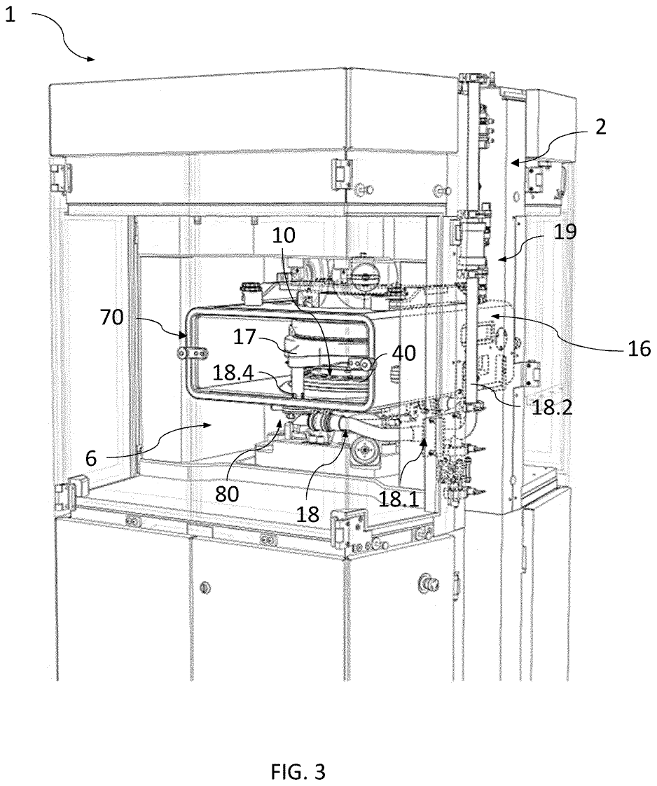

The dust extraction system 16 may be attached to any structurally stable parts of the rotary tablet press 1 in any suitable manner. As indicated in for instance FIGS. 2 and 3, but not described in detail, fittings allow attachment to the housing 2 of the rotary tablet press 1.

In the embodiment shown, in which the turret 10 is accommodated in the enclosure 70, the extraction nozzle 17 is also located within the enclosure 70. The piping of the dust extraction system 16 comprises the dust extraction pipe 18, which connects the extraction nozzle 17 with the suction device 19 of the dust extraction system, and the dust extraction pipe 18 thus penetrates the bottom wall 71 of the enclosure 70 as will be described in further detail below.

In order to allow emptying of the filling device 12 during standstill of the rotary tablet press 1, either as part of a scheduled cleaning procedure according to a cleaning regimen, after a finalized production run, a test run, or in case of feeder jamming, the rotary tablet press 1 comprises an emptying arrangement 80 configured to allow emptying the filling device 12 of residual powder.

According to the invention, the emptying arrangement 80 is connected to or connectable to the dust extraction system 16 of the rotary tablet press 1. In the embodiment shown, the emptying arrangement 80 comprises a powder discharge pipe 81 connected to the filling device 12 when the rotary tablet press 1 is in its operational position. However, it is also conceivable to form the emptying arrangement 80 as a separate entity which is then connected to the filling device 12 and to the dust extraction system 16 during preparation for the cleaning procedure. In that case, means allowing contained connection are typically used, one example being Layflat Tubing (LTF).

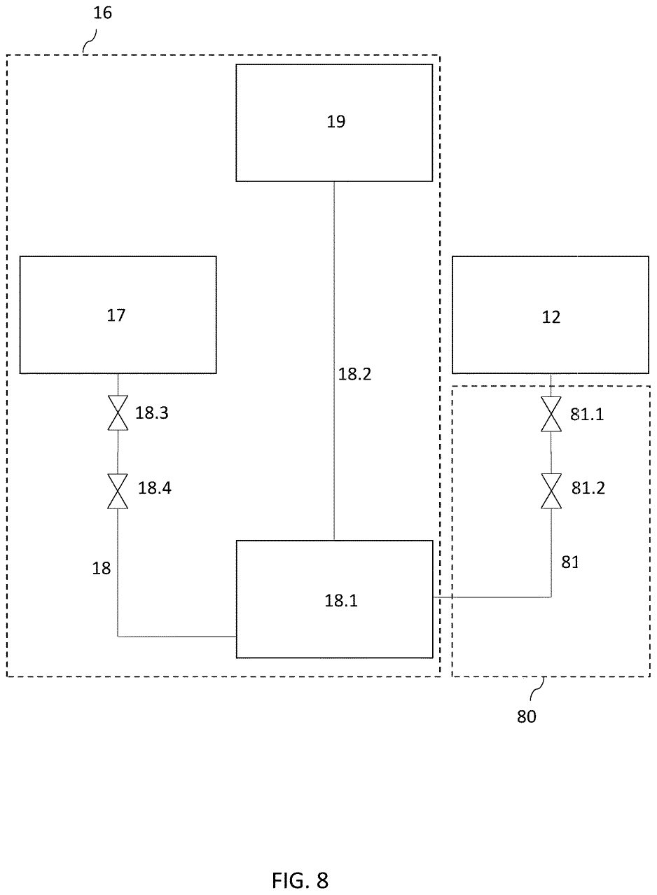

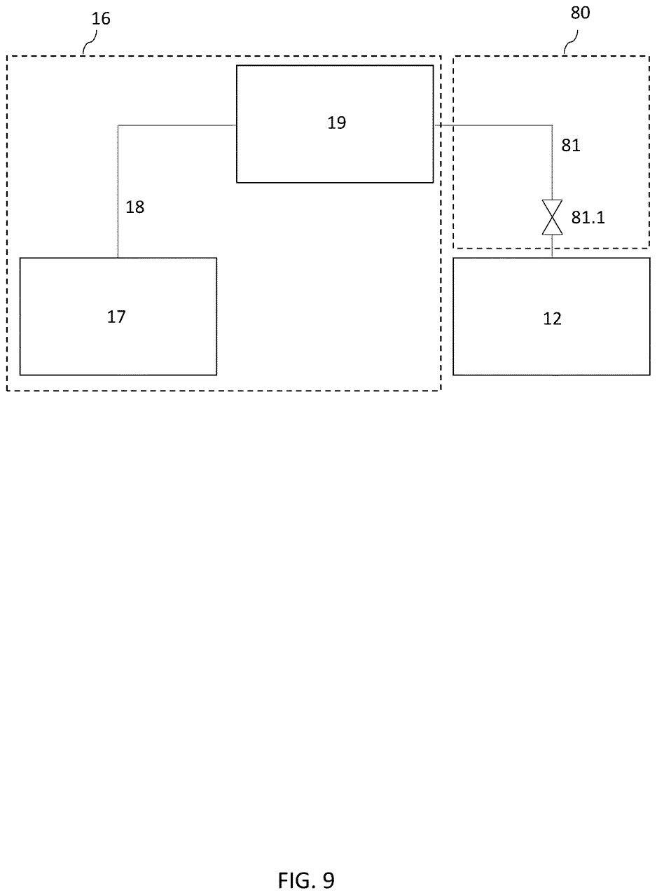

Regarding the connection between the emptying arrangement 80 and the dust extraction system 16, the powder discharge pipe 81 of the emptying arrangement 80 may either be connected to the piping of the dust extraction system 16, here to the dust extraction pipe 18, as shown in the embodiments of FIGS. 2 to 7, or directly to the suction device 19. In that regard, reference is also made to the schematic overviews of FIGS. 8 and 9, of which FIG. 8 shows an overview corresponding to the embodiments of FIGS. 2 to 7, and FIG. 9 depicts the configuration of a direct connection between the filling device 12 and the suction device 19.

In the embodiment shown, the dust extraction pipe 18 of the dust extraction system 16 is connected to the powder discharge pipe 81 by means of a manifold 18.1, and the piping of the dust extraction system 16 comprises a suction pipe 18.2 connecting the manifold 18.1 with the suction device 19 of the dust extraction system.

To allow for simple establishment of fluid communication between the dust extraction system 16 and the emptying system 80, the powder discharge pipe 81 of the emptying arrangement is connected to the manifold 18.1.

The above-described configurations allow for fluid communication between the extraction nozzle 17 and the suction device 19 on one hand, and between the filling device 12 and the suction device 19 on the other. In order to control the flow of powder, it may be desirable to close off the dust extraction pipe 18 when carrying out the emptying procedure, and to close off the powder discharge pipe 81 when rotary tablet press 1 is in operation. The closing off could in principle be full or partial, such that for instance only the dust extraction pipe 18 between the extraction nozzle 17 and the suction device 19 is open during operation of the rotary tablet press 1, and conversely, allow for fluid communication between the filling device 12 and the suction device 19 via the powder discharge pipe 81 when the rotary tablet press 1 is at standstill.

To this end, the flow of residual powder in the powder discharge pipe 81 of the emptying arrangement 80 may be controlled by means of at least one valve in the embodiments shown. Each such valve is configured to assume a plurality of operational positions including a closed and an open position. Partially closed operational positions are also conceivable, as are other positions.

A first valve comprises a shut-off valve 81.1 associated to the filling device 12 and configured to assume a closed position during operation of the rotary tablet press 1 and an open position during an emptying procedure so as to establish connection between the filling device 12 and the powder discharge pipe 81 in the open position of the shut-off valve 81.1.

Reverting briefly to the schematic overviews of FIGS. 8 to 10, it is highlighted that the relatively basic embodiment shown in FIG. 9 provides for efficient emptying by means of few components. As shown, the emptying arrangement 80 here comprises only the powder discharge pipe 81 and the shut-off valve 81.1, such that on connecting the emptying arrangement 80 to the filling device 12 on the one hand, and to the suction device 19 of the dust extraction system 16 on the other, it is possible to establish communication between the filling device 12 and the dust extraction system 16 via the emptying arrangement 80 by simply opening the shut-off valve 81.1. The emptying arrangement 80 may remain in position during operation, but then the shut-off valve 81.1 may rather be closed.

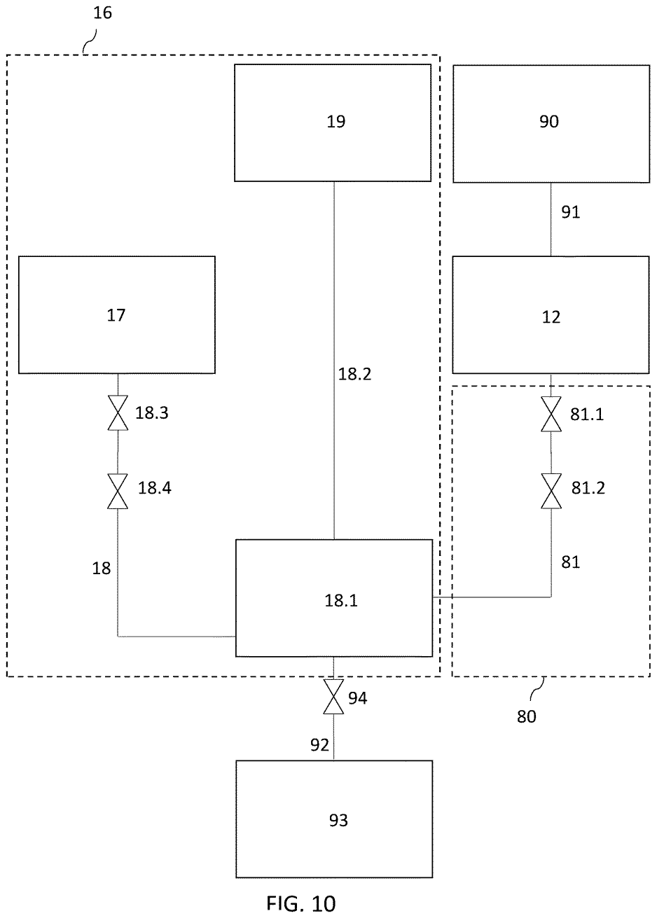

The functionality of the emptying arrangement 80 depicted in FIGS. 8 and 10 corresponds in substance to the basic embodiment of FIG. 9; the dust extraction system 16 comprises manifold 18.1, and the emptying arrangement 80 comprises an additional valve, namely draining valve 81.2, allowing for drainage of any fluid present in or added to the rotary tablet press 1.

In the dust extraction system 16 of the embodiments of FIGS. 8 and 10, a second valve 18.3 is associated to the dust extraction pipe 18 leading from the extraction nozzle 17 and is configured to assume an open position during operation of the rotary tablet press and a closed position during the emptying procedure of the filling device 12. Corresponding to the draining valve 81.2 of the emptying arrangement 80, the dust extraction system 16 comprises a draining valve 18.4 in these embodiments.

The emptying arrangement 80 may be built into the rotary tablet press 1, or be supplied as an additional feature, for instance for retrofitting.

Connection between the individual pipes and valves is carried out in any suitable manner, typically by means of contained connections allowing a suitable degree of containment. Suitable forms include LFTs or a quick coupling such as a bayonet coupling incorporated into the valve body.

By the term “contained connection” is herein to be understood that the connection is to fulfil certain requirements to containment, i.e. that the connection is at least dust tight. Correspondingly, a contained connection may be a connection configured to prevent that extensive amounts, such as detectable amounts and/or amounts over a certain threshold, of an input composition, which the turret of the rotary tablet press is processing, are emitted from the contained connection into the surroundings, such as into a room in which it is arranged or into an enclosure surrounding at least a part of the turret. By “contained connection” may herein be understood that the connection is to have a containment capability of dust containment of up to 10 μg per m³.

By the above arrangement, the dust extraction system 16 is able to be operative during operation of the rotary tablet press 1 for extracting dust from the extraction nozzle 17 by the suction device 19 as well as during the emptying procedure in which the filling device 12 is emptied for residual powder. Selective opening and closing of the valves 81.1 and 18.3 allow for optimum extraction and emptying performance.

A method of cleaning a rotary tablet press such as the rotary tablet press 1 described in the above thus typically involves the steps of:
connecting the emptying arrangement 80 to the dust extraction system 16 of the rotary tablet press 1, and
carrying out an emptying procedure to empty the filling device 12 of residual powder by sucking the residual powder by means of the suction device 19 of the dust extraction system 16.

The step of connecting the emptying arrangement 80 to the dust extraction system 16 comprises opening a first valve comprising shut-off valve 81.1 associated to the filling device 12 to establish connection between the filling device 12 and a powder discharge pipe 81.

If a second valve is provided, such as valve 81.3 associated to the dust extraction pipe 18 leading from the extraction nozzle 17, this valve 81.3 is brought to a closed position before initiating the emptying procedure.

In a further embodiment of the rotary tablet press, the emptying arrangement 80 is configured to be connected to a washing system. An exemplary configuration of such a further embodiment is shown in FIG. 10, in which the washing system 90 is connected to the emptying arrangement 80 by means of a washing pipe 91 leading to the filling device 12.

As shown in FIG. 10, the further embodiment has a set-up corresponding to the one of FIG. 8, and the manifold 18.1 is connected to a draining pipe 92 leading to a drainage discard system 93, here via a draining valve 94.

The method of cleaning the rotary tablet press 1 described in the above may then comprise the additional step of supplying a washing fluid to the filling device following the emptying procedure. The washing fluid is typically water but may also comprise a cleaning liquid comprising a detergent.

As a further aspect, a rotary tablet press is provided, comprising a housing with a compression section, a turret positioned in the compression section in an operational position, a dust extraction system comprising a dust extraction pipe and optionally an emptying arrangement comprising a powder discharge pipe, and an enclosure surrounding the turret in its operational position in the compression section of the rotary tablet press, said enclosure comprising a bottom wall, a top wall, and a plurality of side walls extending between the bottom wall and the top wall. In this aspect, the dust extraction pipe and/or the powder discharge pipe is provided with a draining valve.

In a further development of this aspect, the bottom wall of the enclosure is provided as a plurality of hopper shapes, preferably comprising a rear and front hopper shape in the bottom wall of the enclosure, or as comprising two inclined inner portions.

While the above described further aspect is applicable independently to rotary tablet presses in which there is no connection between the dust extraction system and the emptying arrangement, the further aspect is applicable to embodiments of the present invention as well.

Thus, as indicated in FIGS. 2 to 7, and 8 and 10, the dust extraction pipe 18 and the powder discharge pipe 81 are both provided with a draining valve 18.4, 81.2.

In particular in embodiments comprising manifold 18.1 and washing system 90, it is advantageous that the powder discharge pipe 81 of the emptying arrangement 80 is connected to the manifold 18.1 at a level above the connection of the dust extraction pipe 18 to the manifold 18.1.

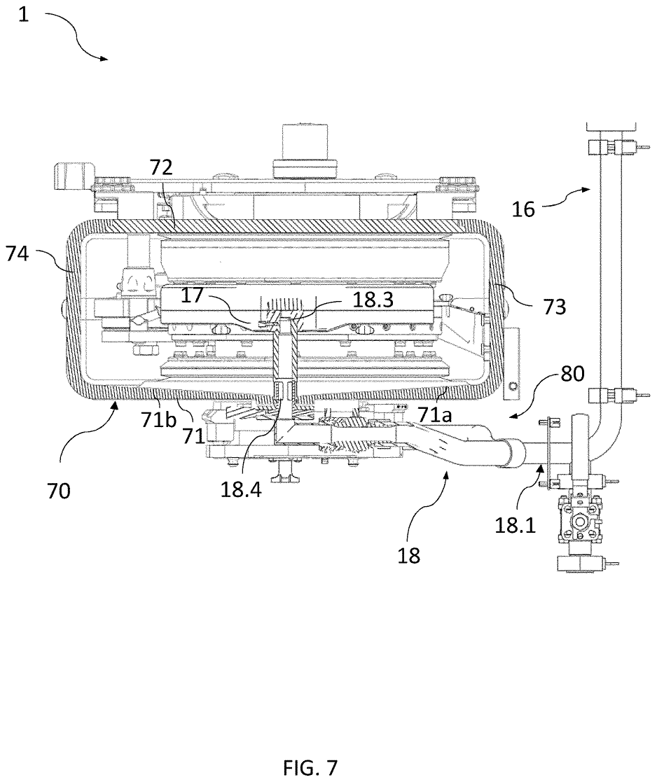

Improved draining conditions for any dust and/or washing fluid remaining within the enclosure 70 are obtained by the feature shown most clearly in the cross-sectional drawings of FIGS. 6 and 7, namely that the bottom wall 71 of the enclosure 70 comprises two inclined inner portions 71a, 71b.

### LIST OF REFERENCE NUMERALS

1 rotary tablet press
2 housing
2a wall element
2b display
3 frame
4 outer lining
5 drive section
6 compression section
7 bottom frame
8 accessory section
9 top frame
10 turret
11 tablet chute
12 filling device
13 powder inlet tube
14 powder distribution device/fill shoe
15 feeder
16 dust extraction system
17 extraction nozzle
18 piping/dust extraction pipe
18.1 manifold
18.2 suction pipe
18.3 second valve (at extraction nozzle)
18.4 draining valve
19 suction device
40 die disc
60 suspension device
70 enclosure
71 bottom wall
71a first inclined inner portion of bottom wall
71b second inclined inner portion of bottom wall
72 top wall
72.2 aperture for powder inlet tube
73 first side wall
74 second side wall
77 end cover
78 end cover
80 emptying arrangement
81 powder discharge pipe
81.1 first valve/shut-off valve at filling device
81.2 draining valve
90 washing system
91 washing pipe
92 draining pipe
93 drainage discharge system
94 draining valve

What is claimed is:

1. A rotary tablet press comprising:
a housing with a compression section;
a turret positioned in the compression section in an operational position;
at least one filling device associated with the turret; and
a dust extraction system including a suction device, piping, and an extraction nozzle having an opening in the compression section, the dust extraction system being configured to extract dust from the compression section to the suction device via the piping of the dust extraction system during operation of the rotary tablet press,
wherein the rotary tablet press comprises an emptying arrangement configured to allow emptying the filling device of residual powder, and
wherein the emptying arrangement is connected to or connectable to the dust extraction system of the rotary tablet press.

2. The rotary tablet press according to claim 1, wherein the emptying arrangement comprises a powder discharge pipe connected to or connectable to the filling device and configured to bring the filling device in connection with the suction device of the dust extraction system.

3. The rotary tablet press according to claim 2, wherein the piping of the dust extraction system comprises a dust extraction pipe connecting the extraction nozzle with the suction device of the dust extraction system, and wherein the powder discharge pipe of the emptying arrangement is connected to the dust extraction pipe.

4. The rotary tablet press according to claim 3, wherein the dust extraction pipe of the dust extraction system is connected to the powder discharge pipe by means of a manifold and wherein the piping of the dust extraction system comprises a suction pipe connecting the manifold with the suction device of the dust extraction system.

5. The rotary tablet press according to claim 4, wherein the powder discharge pipe of the emptying arrangement is connected to the manifold

6. The rotary tablet press according to claim 2, wherein the powder discharge pipe of the emptying arrangement is configured to bring the filling device in direct connection with the suction device of the dust extraction system.

7. The rotary tablet press according to claim 3, wherein the emptying arrangement is selectively connectable to and disconnectable from the dust extraction system by means of at least one valve configured to assume a plurality of operational positions including a closed and an open position.

8. The rotary tablet press according to claim 7, wherein a first valve comprises a shut-off valve associated to the filling device and configured to assume a closed position during operation of the rotary tablet press and an open position during an emptying procedure so as to establish connection between the filling device and the powder discharge pipe in the open position of the shut-off valve.

9. The rotary tablet press according to claim 7, wherein a second valve is associated to the dust extraction pipe leading from the extraction nozzle and configured to assume an open position during operation of the rotary tablet press and a closed position during an emptying procedure of the filling device.

10. The rotary tablet press according to claim 5, wherein the emptying arrangement is configured to be connected to a washing system.

11. The rotary tablet press according to claim 10, wherein the manifold is connected to a draining pipe leading to a drainage discard system.

12. The rotary tablet press according to claim 11, wherein one or more of the dust extraction pipe or the powder discharge pipe is provided with a draining valve.

13. The rotary tablet press according to claim 11, wherein the powder discharge pipe of the emptying arrangement is connected to the manifold at a level above a connection of the dust extraction pipe to the manifold.

14. The rotary tablet press according to claim 1, wherein the rotary tablet press comprises an enclosure surrounding the turret in its operational position in the compression section of the rotary tablet press, the enclosure comprising a bottom wall, a top wall substantially parallel to the bottom wall, and a plurality of side walls extending between the bottom wall and the top wall.

15. The rotary tablet press according to claim 14, wherein the bottom wall of the enclosure is provided as a plurality of hopper shapes.

16. A method of cleaning the rotary tablet press according to claim 1, comprising:
connecting the emptying arrangement to the dust extraction system of the rotary tablet press, and
carrying out an emptying procedure to empty the filling device of residual powder by sucking the residual powder using the suction device of the dust extraction system.

17. The method of claim 16, wherein connecting the emptying arrangement to the dust extraction system comprises opening shut-off valve associated to the filling device to establish connection between the filling device and the powder discharge pipe of the emptying arrangement.

18. The method of claim 17, wherein a second valve associated to a dust extraction pipe leading from the extraction nozzle of the dust extraction system is brought to a closed position before initiating the emptying procedure.

19. The method of claim 16, further comprising supplying a washing fluid to the filling device following the emptying procedure.

20. The rotary tablet press according to claim 15, wherein the plurality of hopper shapes comprises a rear and front hopper shape in the bottom wall of the enclosure or two inclined inner portions.
